(19) United States
(12) Patent Application Publication
(10) Pub. No.: US 2014/0288781 A1
(43) Pub. Date: Sep. 25, 2014

(54) OCCUPANT PROTECTION APPARATUS FOR VEHICLE

(71) Applicant: DENSO CORPORATION, Kariya-city (JP)

(72) Inventor: Takeshi Horiguchi, Kariya-city (JP)

(73) Assignee: DENSO CORPORATION, Kariya-city (JP)

(21) Appl. No.: 14/217,613

(22) Filed: Mar. 18, 2014

(30) Foreign Application Priority Data
Mar. 19, 2013 (JP) 2013-056932

(51) Int. Cl. G08B 25/10; B60R 21/01; B60R 21/013; G08B 29/18

(52) U.S. Cl. CPC G08B 25/10; G08B 29/181; B60R 21/01; B60R 21/013; B60R 2021/01109
USPC 701/45

(57) ABSTRACT

A vehicular occupant protection apparatus is provided, which includes: a controller for activating an occupant protector based on a detection result of a vehicle accident detector; a communication circuit for transmitting an accident data to a emergency call apparatus; and a backup circuit connected to the emergency call apparatus for supplying the controller with electric power from a backup battery. When the vehicle accident occurs, the controller performs power control in which the controller turns on the backup circuit and transmits the accident data to the emergency call apparatus by being supplied with the electric power from the backup battery, and turns off the backup circuit after transmitting the accident data to the emergency call apparatus.

### CROSS REFERENCE TO RELATED APPLICATION

The present application is based on and claims priority to Japanese Patent Applications No. 2013-56932 filed on Mar. 19, 2013, disclosure of which is incorporated herein by reference.

### TECHNICAL FIELD

The present disclosure relates to a vehicular occupant protection apparatus for transmitting an accident data such as vehicle speed or the like at a time of a vehicle accident.

### BACKGROUND

It is conventionally known that when a vehicle having an airbag as an occupant protector is involved in a vehicle accident such as a vehicle collision, a vehicular occupant protection apparatus (e.g., airbag ECU) activates the airbag and sends an emergency call from an in-vehicle emergency call apparatus to a center. In this kind of vehicle, in case that the supply of electric power from an in-vehicle battery is cut, a backup capacitor for activating the airbag and a backup battery (power source) for the emergency call are disposed inside the vehicular occupant protection apparatus (see Patent Document 1).

When the supply of electric power from the in-vehicle batter is cut due to the occurrence of the vehicle accident, a power source supplying the electric power to the emergency call apparatus switches from the in-vehicle battery to the backup battery, so that the emergency call apparatus is supplied with the electric power from the backup battery to make an emergency call.

Patent Document 1: JP 2008-213714A

In recent years, it is proposed that an accident data such as vehicle speed and the like at a time of accident is recorded in an event data recorder (EDR) and this accident data is transmitted to the service center to provide life-saving service, first-aid service and medical treatment service. Implementation of this service in the above-described vehicle may require that the accident data should be stored in a memory in the vehicular occupant protection apparatus and this accident data should be sent from the emergency call apparatus to the service center.

However, in order to transmit the accident data stored in the vehicular occupant protection apparatus to the emergency call apparatus, the vehicular occupant protection apparatus should include a large capacity backup capacitor or multiple backup capacitors in preparation for communications at the time when the electric power supply is cut. This enlarges the apparatus and increases the cost.

### SUMMARY

The present disclosure is made in view of the foregoing. It is an object of the present disclosure to provide a vehicular occupant protection apparatus that, while having a simple structure, can transmit an accident data to a vehicle occupant apparatus at a time of occurrence of a vehicle accident.

According to an example of the present disclosure, a vehicular occupant protection apparatus comprises: a vehicle accident detector for detecting an occurrence of a vehicle accident; a controller for putting an occupant protector into operation based on a detection result of the vehicle accident detector; a power supply circuit for supplying electric power to the controller; a backup capacitor for supplying electric power to the power supply circuit at a time of the occurrence of the vehicle accident; a storage device for storing an accident data relating to the vehicle accident; a communication circuit for transmitting the accident data stored in the storage device to an emergency call apparatus that makes an emergency call at the time of the occurrence of the vehicle accident, wherein the communication circuit is connected to the emergency call apparatus; and a backup circuit for supplying the controller with electric power from a backup battery that supplies electric power to the emergency call apparatus for the emergency call, wherein the backup circuit is connected to the emergency call apparatus. When the vehicle accident detector detects the occurrence of the vehicle accident, the controller performs power control in which the controller turns on the backup circuit and transmits the accident data to the emergency call apparatus via the communication circuit by being supplied with the electric power from the backup battery, and turns off the backup circuit after transmitting the accident data to the emergency call apparatus.

According to the above vehicular occupant protection apparatus, at a time of occurrence of a vehicle accident, the controller can transmit the accident data stored in the storage device of the vehicular occupant protection apparatus by turning on the backup circuit and by being supplied with electric power from the backup battery on an emergency call apparatus side. Therefore, with a simple structure, the vehicular occupant protection apparatus can transmit the accident data to the emergency call apparatus at the time of the occurrence of the vehicle accident. Accordingly, it is unnecessary to dispose a large capacity backup capacitor inside the vehicular occupant protection apparatus, and it is possible to downsize the apparatus and reduce the cost. Furthermore, because the controller turns off the backup circuit after transmitting the accident data, wasteful supply of electric power from the backup battery can be eliminated. It is possible to minimize an electric power consumption of the emergency call apparatus, and it is possible to reduce an influence on an emergency call operation of the emergency call apparatus.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram illustrating an electric configuration of a vehicular occupant protection apparatus of one embodiment; and

FIG. 2 is a flowchart illustrating a control process for transmitting accident data from a vehicular occupant protection apparatus to an emergency call apparatus.

### DETAILED DESCRIPTION

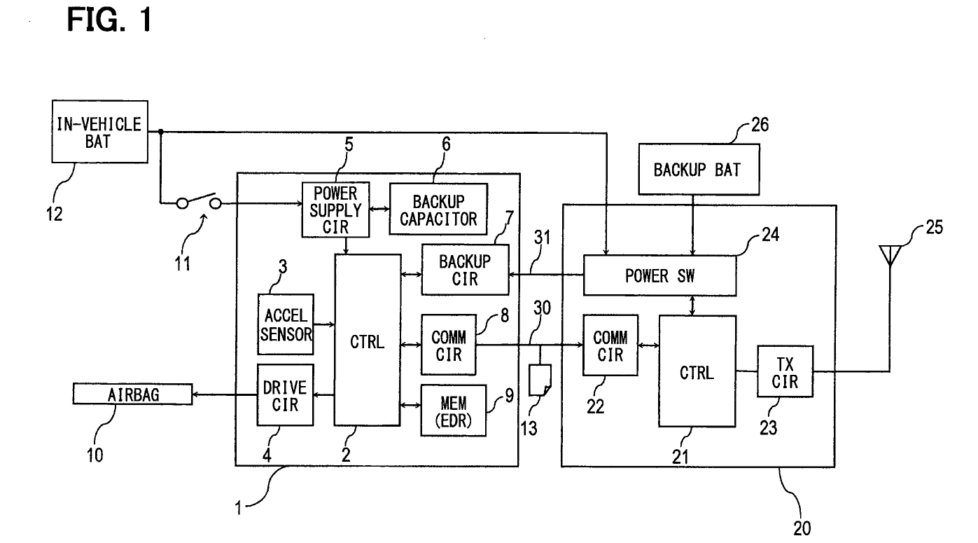

A vehicular occupant protection apparatus of one embodiment will be described with reference to the drawings. As shown in FIG. 1, a vehicular occupant protection apparatus 1 of the present embodiment includes a controller 2 (corresponding to a control device), an acceleration sensor 3 (corresponding to a vehicle accident detector), a drive circuit 4, a power supply circuit 5, a backup capacitor 6, a backup circuit 7, a communication circuit 8, and a memory 9 (corresponding to a storage device).

The controller 2 includes a CPU as its main component and controls generally whole operations of the vehicular occupant protection apparatus 1. The controller 2 is connected to the acceleration sensor 3, the drive circuit 4, the power supply circuit 5, the backup circuit 7, the communication circuit 8, and the memory 9.

The acceleration sensor 3 (G sensor) detects impact on the vehicle. The acceleration sensor 3 is disposed inside the vehicular occupant protection apparatus 1, at a front part of the vehicle, at a left part of the vehicle, at a right part of the vehicle, at a rear part of the vehicle, and/or another part. The acceleration sensor 3 detects an acceleration at the above part and outputs the detected acceleration value as an acceleration signal to the controller 2. The drive circuit 4 is electrically connected to an airbag 10 serving as occupant protector, and outputs a deployment signal to the airbag 10. The airbag 10 is a vehicle safety device for absorbing an impact on a driver by inflating an airbag at a time of a vehicle accident such as collision accident or the like. In the present embodiment, the vehicular occupant protection apparatus 1 functions as an airbag electronic control unit (ECU) controlling an operation of the airbag 10. It is noted that the vehicular occupant protection apparatus 1 is not limited to the airbag ECU. The vehicular occupant protection apparatus 1 may be, for example, a seat-belt apparatus for binding a driver on a seat, a steering apparatus including a built-in impact absorbing mechanism in a steering column, a brake pedal apparatus for absorbing an impact by moving back at an occurrence of the impact, or the like.

The controller 2 receives an input of the acceleration signal from the acceleration sensor 3 and is supplied with electric power via the power supply circuit 5. The controller 2 determines an occurrence of a vehicle accident based on the input from the acceleration sensor 3. In the present embodiment, when the acceleration value detected with the acceleration sensor 3 becomes equal to or larger than a predetermined threshold, the controller 2 determines that a vehicle accident occurs, and the controller 2 activates (puts into operation) the airbag 10 via the drive circuit 4.

The power supply circuit 5 is connected to the in-vehicle battery 12 via an ignition switch 11 (IG switch) and is connected to the backup capacitor 6. In normal times excluding a time of vehicle accident, when the IG switch 11 is turned on, the in-vehicle battery 12 supplies electric power to the power supply circuit 5. When this electric power is supplied to the controller 2, the in-vehicle occupant protection apparatus 1 operates.

When the controller 2 determines that a vehicle accident occurs, the backup capacitor 6 supplies electric power to the controller 2 via the power supply circuit 5. By being supplied with the electric power from the backup capacitor 6, the controller 2 activates (puts into operation) the airbag 10 via the drive circuit 4.

The backup circuit 7 performs an on-operation and an off-operation based on a signal from the controller 2. The backup circuit 7 is connected to the emergency call apparatus 20 and supplies electric power to the controller 2 from the emergency call apparatus 20. The communication circuit 8 is connected to the emergency call apparatus 20. At a time of occurrence of a vehicle accident, an emergency call signal from the controller 2 is transmitted to the emergency call apparatus 20 by the communication circuit 8.

The memory 9 (e.g., event data recorder (EDR)) includes a non-volatile memory and stores accident data 13 such as a vehicle speed or the like at a time of occurrence of a vehicle accident. At a time of occurrence of a vehicle accident, the controller 2 transmits, together with the above-described emergency call signal, the accident data stored in the memory 9 to the emergency call apparatus 20 via the communication circuit 8. The accident data 13 includes: information on an impact (e.g., accelerations in front/rear/left/right directions detected with the acceleration sensor 3); information on control of the airbag 10 (e.g., airbag deployment time); a driver's operation status (e.g., accelerator operation amount, engine revolution, vehicle speed, presence or absence of braking operation); information on an occupant (e.g., use or non-use of a seat-belt, occupant physical size, seat position); and failure information (e.g., diagnostic code, warning lamp state). These kinds of vehicle information around the occurrence of the vehicle accident, e.g., few seconds prior to and after the occurrence of the vehicle accident, are recorded. The emergency call apparatus 20 sends this accident data 13 to a service center. In cooperation with various agencies such police, emergency service and the like, the accident data is used for life-serving, first-aid, treatment of the occupant, and is used for accident investigation.

Next, the emergency call apparatus 20 (e.g., Data Communication Module: DCM) will be described with reference to FIG. 1. As shown in FIG. 1, the emergency call apparatus 20 includes a controller 21, a communication circuit 22, a transmission circuit 23 and a power supply switching unit 24, and is mounted in a vehicle. The emergency call apparatus 20 makes an emergency call to notify an external agency such as a service center or the like that a vehicle has a trouble such as collision accident or the like.

The controller 21 includes a CPU as its main component and controls generally whole operations of the emergency call apparatus 20. The controller 21 is connected to the communication circuit 22, the transmission circuit 23 and the power supply switching unit 24.

The communication circuit 22 is connected to the communication circuit 8 of the vehicular occupant protection apparatus 1 via a communication cable 30 and transmits the emergency call signal and the accident data 13 to the controller 21. The transmission circuit 23 is connected to a communication antenna 25. The emergency call signal and the accident data 13 inputted to the controller 21 are sent to the service center (not shown) from the communication antenna 25 by wireless communication.

An operator is resident in the service. When the service center receives emergency information such as accident or first-aid, the operator can talk with the driver via the emergency call apparatus 20 or a cellular phone of the driver. Then, on an as-needed basis, the operator of the service center performs emergency call service such as notifying polices or hospitals.

The power supply switching unit 24 is connected to the in-vehicle battery 12 and the backup battery 26 and supplies electric power to the controller 21 by switching between the in-vehicle battery 12 and the backup battery 26. In the present embodiment, the power supply switching unit 24 is also connected to the backup circuit 7 of the vehicular occupant protection apparatus 1 via a power supply cable 31.

The backup battery 26 includes, for example, a primary battery, and is provided separately from the emergency call apparatus 20. The backup battery 26 has a function to supply the emergency call apparatus 20 with the electric power for the emergency call when the in-vehicle battery 12 becomes incapable of supplying the electric power to the emergency call apparatus 20 due to, for example, disconnection of a connection wire at the time of an occurrence of a vehicle accident. In the present embodiment, the electric power of the backup battery 26 is also supplied to the backup circuit 7 of the vehicular occupant protection apparatus 1 via the power supply cable 31 and is also used as the electric power for transmitting the accident data 13. That is, in the present embodiment, for supplying the electric power to the vehicular occupant protection apparatus 1, the backup battery 26 is not directly connected to the vehicular occupant protection apparatus 1 but indirectly connected to the vehicular occupant protection apparatus 1 via the emergency call apparatus 20.

The power supply switching unit 24 includes a change-over switch and a diode (not shown). In normal times during which no vehicle accident occurs, the change-over switch is maintained at OFF, so that the electric power from the in-vehicle battery 12 is supplied to the controller 21 via the diode. At a time of occurrence of a vehicle accident, the change-over switch is changed from OFF to ON and the power source supplying the operating power is changed to the backup battery 26, so that the electric power from the backup battery 26 is supplied to the controller 21 via the change-over switch.

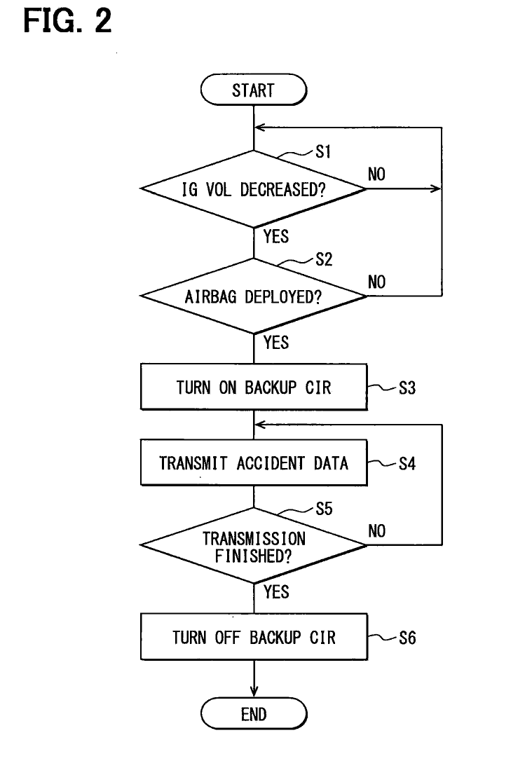

Next, a control flow for the vehicular occupant protection apparatus 1 to transmit the accident data to the emergency call apparatus 20 will be described with reference to FIG. 2.

At S1, the controller 2 of the vehicular occupant protection apparatus 1 determines whether or not the IG voltage of the vehicle is less than or equal to a predetermined threshold. If the supply of electric power from the in-vehicle battery 12 is cut or a power supply path has a failure due to an occurrence of a vehicle accident or the like, the IG voltage decreases or becomes zero. When the controller 2 determines that the IG voltage is less than or equal to the predetermined threshold (S1: YES), the controller 2 determines whether or not the airbag is deployed (S2).

As described above, the controller 2 determines whether or not a vehicle accident occurs based on the output from the acceleration sensor 3. When the acceleration detected with the acceleration sensor 3 is greater than or equal to a predetermined threshold, the controller 2 deploys the airbag 10. In this case, the electric power for putting the airbag 10 into operation is sent from the backup capacitor 6 to the controller 2 via the power supply circuit 5.

When the airbag is deployed (S2: YES), the controller 2 turns on the backup circuit 7 (S3). As shown in FIG. 1, when the backup circuit 7 is put into operation (i.e., turned on), the electric power is supplied from the backup battery 26 to the backup circuit 7 via the power supply switching unit 24. By the electric power from the backup circuit 7, the controller 2 transmits the accident data 13 stored in the memory 9 to the emergency call apparatus 20 via the communication circuit 8 (S4). The controller 2 continues to perform transmission before finishing transmitting the accident data 13 (S5: No, S4). When finishing transmitting the accident data 13 (S5: YES), the controller 2 turns off the backup circuit 7 (S6).

The emergency call signal and the accident data 13 transmitted to the communication circuit 22 of the emergency call apparatus 20 are transmitted to the communication antenna 25 via the transmission circuit 23. This communication antenna 25 sends the emergency call signal and the accident data 13 to the service center by wireless communication. After transmitting the accident data 13, the emergency call apparatus 20 can perform the emergency call operation by being supplied with the electric power from the backup battery 26.

As described above, the vehicular occupant protection apparatus 1 of the present embodiment includes the acceleration sensor 3 for detecting an occurrence of a vehicle accident, the controller 2 for putting the airbag 10 into operation based on the detection by the acceleration sensor 3, the power supply circuit 5 for supplying electric power to the controller 2, the backup capacitor 6 for supplying electric power to the power supply circuit 5 at a time of the occurrence of the vehicle accident, the memory 9 for storing accident data 13 relating to the vehicle accident, the communication circuit 8 for transmitting the accident data 13 stored in the memory 9 to the emergency call apparatus 20, and the backup circuit 7 for supplying the controller 2 with electric power from the backup battery on an emergency call apparatus 20 side. When the acceleration sensor 3 detects the occurrence of the vehicle accident, the controller 2 perform power control in which: the controller 2 turns on the backup circuit 7 (S3), and transmits the accident data 13 to the emergency call apparatus 20 via the communication circuit 8 (S4) by being supplied with the electric power from the backup battery 26; and the controller 2 turns off the backup circuit 7 (S6) after finishing transmitting the accident data 13 (S5: YES).

According to this configuration, at a time of occurrence of a vehicle accident, the controller 2 can transmit the accident data stored in the memory 9 to the emergency call apparatus 20 by turning on the backup circuit 7 and by being supplied with the electric power from the backup battery 26 via the emergency call apparatus 20. Therefore, with a simple structure, it is possible to transmit the accident data to the emergency call apparatus 20 at a time of occurrence of a vehicle accident. Specifically, it is not required that a large capacity backup capacitor is provided inside the vehicular occupant protection apparatus 1 in order to transmit the accident data 13. It becomes possible to downsize the apparatus and reduce the cost. Moreover, even if the vehicular occupant protection apparatus 1 has intense damage due to collision accident or the like, the electric power from the backup battery on an emergency call apparatus 20 side can be ensured, and thus, the accident data 13 can be surely transmitted.

Furthermore, since the controller 2 turns off the backup circuit 7 after transmitting the accident data 13, wasteful supply of electric power from the backup battery 26 can be eliminated and the power consumption of the backup battery 26 can be minimized. Accordingly, it is possible to transmit the accident data 13 while minimizing an influence on the emergency call operation of the emergency call apparatus 20.

Furthermore, in normal times excluding a time of occurrence of a vehicle accident, electric power from the backup battery 26 on an emergency call apparatus 20 side is not supplied to the controller 2 of the vehicular occupant protection apparatus 1, and thus, power control by the controller 2 of the vehicular occupant protection apparatus 1 in the normal times is not influenced by the backup battery 26.

The above-illustrated embodiment does not limit embodiments of the present disclosure and can be modified and extended in various ways.

For example, in the above-illustrated embodiment, the acceleration sensor 3 is used as a vehicle accident detector. Alternatively, a pressure sensor disposed inside a vehicle door or the like may detect an occurrence of a vehicle accident. In this case, when a detection value of the pressure sensor becomes equal to or greater than a predetermined threshold, it is determined that the vehicle accident occurs. Alternatively, a determination of whether a. vehicle accident occurs may be made based on detection results of multiple sensors.

In the above-illustrated embodiment, after it is determined that the IG voltage is less than or equal to a predetermined threshold (S1) and it is determined that the airbag 10 is deployed (S2), the backup circuit 7 is turned on. Alternatively, for example, when the acceleration detected with the acceleration sensor 3 becomes equal to or greater than a predetermined threshold, the backup circuit 7 may be immediately put in operation and the accident data 13 may be transmitted. According to this configuration, because the accident data 13 is transmitted regardless of the IG voltage and the deployment of the airbag 10, the accident data 13 can be surely sent to the service center even when an IG voltage detector and/or a communication circuit disposed in an airbag fails due to a vehicle accident.

In the above-illustrated embodiment, the communication cable 30 for transmitting the accident data 13 and the power supply cable 31 for supplying electric power from the backup battery 26 are different cables. Alternatively, a same wiring may be used for transmitting the accident data 13 and supplying electric power from the backup battery 26. For example, the vehicular occupant protection apparatus 1 and the emergency call apparatus 20 may be connected by a power cable and the accident data 13 may be transmitted from the vehicular occupant protection apparatus 1 to the emergency call apparatus 20 by electric-current communication, in which communication is performed by increasing and decreasing a current. According to this configuration, a wiring between the vehicular occupant protection apparatus 1 and the emergency call apparatus 20 can be simplified.

In the above-illustrated embodiment, the backup battery 26 and the emergency call apparatus 20 are provided separately from each other. Alternatively, the backup battery 26 may be built in the emergency call apparatus 20.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicular occupant protection apparatus comprising:
a vehicle accident detector for detecting an occurrence of a vehicle accident;
a controller for putting an occupant protector into operation based on a detection result of the vehicle accident detector;
a power supply circuit for supplying electric power to the controller;
a backup capacitor for supplying electric power to the power supply circuit at a time of the occurrence of the vehicle accident;
a storage device for storing an accident data relating to the vehicle accident;
a communication circuit for transmitting the accident data stored in the storage device to an emergency call apparatus that makes an emergency call at the time of the occurrence of the vehicle accident, wherein the communication circuit is connected to the emergency call apparatus; and
a backup circuit for supplying the controller with electric power from a backup battery that supplies electric power to the emergency call apparatus for the emergency call, wherein the backup circuit is connected to the emergency call apparatus,
wherein:
when the vehicle accident detector detects the occurrence of the vehicle accident, the controller performs power control in which
the controller turns on the backup circuit and transmits the accident data to the emergency call apparatus via the communication circuit by being supplied with the electric power from the backup battery, and turns off the backup circuit after transmitting the accident data to the emergency call apparatus.

2. The vehicular occupant protection apparatus according to claim 1, wherein:
the vehicle accident detector includes an acceleration sensor disposed in the vehicle; and
when an acceleration detected with the acceleration sensor is greater than or equal to a threshold, the controller performs the power control.

3. The vehicular occupant protection apparatus according to claim 1, wherein:
when (i) the vehicle accident detector detects the occurrence of the vehicle accident and (ii) the occupant protector is put into operation, the controller performs the power control.

4. The vehicular occupant protection apparatus according to claim 1, wherein:
when the vehicle accident detector detects the occurrence of the vehicle accident after an ignition voltage of the vehicle falls below a threshold, the controller performs the power control.

5. The vehicular occupant protection apparatus according to claim 1, wherein:
(i) transmission of the accident data between the vehicular occupant protection apparatus and the emergency call apparatus and (ii) supply of the electric power from the backup battery to the vehicular occupant protection apparatus are simultaneously performed via a same wiring.
